(19) United States
(12) Patent Application Publication
(10) Pub. No.: US 2021/0306946 A1
(43) Pub. Date: Sep. 30, 2021

(54) SECONDARY NETWORK NODE SELECTION FOR DUAL CONNECTIVITY

(71) Applicant: Telefonaktiebolaget LM Ericsson (publ), Stockholm (SE)

(72) Inventors: György MIKLÓS, Pilisborosjenö (HU); Paul SCHLIWA-BERTLING, Ljungsbro (SE)

(21) Appl. No.: 17/268,095

(22) PCT Filed: Aug. 13, 2019
(86) PCT No.: PCT/SE2019/050741

§ 371 Date: Feb. 12, 2021

Related U.S. Application Data
(60) Provisional application No. 62/718,215, filed on Aug. 13, 2018.

(51) Int. Cl. H04W 48/20; H04W 76/15

(52) U.S. Cl. CPC H04W 48/20; H04W 84/18; H04W 76/15

(57) ABSTRACT

Methods and apparatuses are disclosed for selecting a secondary network node for dual connectivity. In one embodiment, a method in a network node includes operating in a pre-dual connectivity phase to select a secondary node for establishing dual connectivity for a wireless device already connected to the master node, the selecting being before the establishing, and receiving a trigger to set up dual connectivity via the selected secondary node, the trigger being received after the selection.

### FIELD

The present disclosure relates to wireless communications, and in particular, to secondary network node selection for dual connectivity.

### BACKGROUND

Dual connectivity (DC) was first defined for Evolved Universal Terrestrial Radio Access (E-UTRAN) (3^{rd} Generation Partnership Project (3GPP) Technical Specification (TS) 36.300v15.2.0 section 4.9) as an operation whereby a multiple receiver/transmitter (Rx/Tx) wireless device (WD), such as a user equipment (UE), in RRC CONNECTED state, is configured to utilize radio resources provided by two distinct schedulers located in two network nodes (e.g., eNBs) connected via a non-ideal backhaul over the X2 interface. Multi-Radio Access Technology (Multi-RAT) Dual Connectivity (MR-DC), as defined in 3GPP TS 37.340v15.2.0, can be a generalization of the Intra-E-UTRA Dual Connectivity (DC), where a multiple Rx/Tx WD may be configured to utilize resources provided by two different nodes connected via non-ideal backhaul, one providing E-UTRA access and the other one providing New Radio (NR) access.

Before a dual connectivity can be established with a WD there is a connection with the WD and a network node. The basic setup of dual connectivity is shown in the FIG. 1, where a WD can send and receive data both over a connection to the Master network node (MgNB), and over a connection to the Secondary network node (SgNB). At the set up the MgNB corresponds to the network node in control of the first connection. The core network user plane goes via the User Plane Function (UPF) node, and the splitting of the traffic may take place in the MgNB, or alternatively, in the SgNB, or the traffic may be connected via direct tunnel from UPF to the another gNB, e.g., the SgNB. The radio access network (RAN) control plane may be handled by the MgNB solely. The MgNB is responsible for setting up the connectivity in the SgNB using control signaling.

Besides the basic dual connectivity setup shown in FIG. 1, other more advanced setups are possible. FIG. 2 shows a setup where two Protocol Data Unit (PDU) sessions are used for redundant user plane setup, and the RAN provides redundancy based on dual connectivity. In this approach, RAN is requested to use MgNB for PDU Session 1 and the SgNB for PDU Session 2. This is how two redundant user plane paths can be achieved.

Such a scenario can be achieved in two steps, as shown in FIG. 3. In the first step, both PDU Sessions are established via the MgNB towards different UPFs. Then, RAN is requested to apply dual connectivity for PDU Session 2, and the user plane is then switched to go via the SgNB as a result of the dual connectivity establishment.

### SUMMARY

Some embodiments advantageously provide methods and apparatuses for providing a dual connectivity establishment, split up into at least two phases, that permits the identity of a selected SgNB to be determined prior to establishing the dual connectivity, which may allow for optimizing the dual connectivity set up. In one embodiment, a first phase may include the MgNB determining the SgNB to be used for dual connectivity, and, in some embodiments, informing other network entities about the selected SgNB. The second phase may include establishing dual connectivity at the determined SgNB. In some embodiments, the second phase may be triggered by an explicit signaling.

According to one aspect, a network node configured to operate as a master node is provided. The network node includes processing circuitry configured to: operate in a pre-dual connectivity phase to select a secondary node for establishing dual connectivity for a wireless device already connected to the master node, the selecting being before the establishing, and receive a trigger to set up dual connectivity via the selected secondary node, the trigger being received after the selection.

According to this aspect, in some embodiments, the selecting is based on statistics collected by the network node. In some embodiments, the network node also includes a radio interface configured to communicate an indication of the selected secondary node before establishing dual connectivity for the wireless device. In some embodiments, the communication of the indication of the selected secondary node comprises a communication to a Session Management Function, SMF, for selecting a User Plane Function, UPF, based on the selected secondary node. In some embodiments, the communication of the indication of the selected secondary node enables associating at least one core node to the selected secondary node, the at least one core node being used to establish dual connectivity to the wireless device via the secondary node. In some embodiments, the processing circuitry is further configured to establish the dual connectivity for the wireless device by: establishing a first Protocol Data Unit, PDU, session and a second PDU session via the network node; and releasing the second PDU session with the network node and re-establishing the second PDU session with the secondary node. In some embodiments, the first PDU session and the second PDU session are simultaneous PDU sessions for the wireless device.

According to another aspect, a method in a network node configured to operate as a master node is provided. The method includes operating in a pre-dual connectivity phase to select a secondary node for establishing dual connectivity for a wireless device already connected to the master node, the selecting being before the establishing. The method also includes receiving a trigger to set up dual connectivity via the selected secondary node, the trigger being received after the selection.

According to this aspect, in some embodiments, the selecting is based on statistics collected by the network node. In some embodiments, the method further includes communicating an indication of the selected secondary node before establishing dual connectivity for the wireless device. In some embodiments, the communication of the indication of the selected secondary node comprises a communication to a Session Management Function, SMF, for selecting a User Plane Function, UPF, based on the selected secondary node. In some embodiments, the communication of the indication of the selected secondary node enables associating at least one core node to the selected secondary node, the at least one core node being used to establish dual connectivity to the wireless device via the secondary node. In some embodiments, the processing circuitry is further configured to establish the dual connectivity for the wireless device by: establishing a first Protocol Data Unit, PDU, session and a second PDU session via the network node; and releasing the second PDU session with the network node and re-establishing the second PDU session with the secondary node. In some embodiments, the first PDU session and the second PDU session are simultaneous PDU sessions for the wireless device.

According to yet another aspect, a network node configured to operate as a secondary node is provided. The network node includes processing circuitry configured to: receive an indication from a master node indicating that the network node is selected as a secondary node for establishing dual connectivity with a wireless device; and confirm to the master node that the network node is configurable to act as a secondary node, the receiving and the confirming occurring prior to establishing dual connectivity with the wireless device via the network node. In some embodiments, the processing circuitry is further configured to determine whether the network node is configurable to act as a secondary node based on information received in the indication.

According to another aspect, a method in a network node configured to operate as a secondary node is provided. The method includes receiving an indication from a master node indicating that the network node is selected as a secondary node for establishing dual connectivity with a wireless device. The method also includes confirming to the master node that the network node is configurable to act as a secondary node, the receiving and the confirming occurring prior to establishing dual connectivity with the wireless device via the network node. In some embodiments, the method further includes determining whether the network node is configurable to act as a secondary node based on information received in the indication.

According to yet another aspect, a network node is configured to operate as a master node. The network node 16 includes processing circuitry configured to transmit an indication that a secondary node is selected for establishing dual connectivity with a wireless device, and receive confirmation that the secondary node is configurable to act as a secondary node, the transmitting and receiving occurring prior to establishing dual connectivity with the wireless device via the secondary node.

According to another aspect, a method in a network node configured to operate as a master node is provided. The method includes transmitting an indication that a secondary node is selected for establishing dual connectivity with a wireless device, and receiving confirmation that the secondary node is configurable to act as a secondary node, the transmitting and receiving occurring prior to establishing dual connectivity with the wireless device via the secondary node.

According to yet another aspect, network node configured to operate as a core node is provided. The network node includes processing circuitry configured to: receive an indication from a master node indicating that an intermediate node has been selected as a secondary node for establishing dual connectivity with a wireless device, the receiving occurring before establishing dual connectivity; and operate as a user plane function for a second packet data unit, PDU, session based on the selected secondary node, the second PDU session being a redundant version of a first PDU session.

According to another aspect. method in a network node is configured to operate as a core node. The method includes receiving an indication from a master node indicating that an intermediate node has been selected as a secondary node for establishing dual connectivity with a wireless device, the receiving occurring before establishing dual connectivity. The method further includes operating as a user plane function for a second packet data unit, PDU, session based on the selected secondary node, the second PDU session being a redundant version of a first PDU session.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates a basic dual connectivity setup;

FIG. 2 illustrates a dual connectivity setup based on redundancy with two PDU sessions;

FIG. 3 illustrates two steps of establishing dual connectivity setup based on redundancy for PDU session two;

FIG. 4 is a schematic diagram of an exemplary network architecture illustrating a communication system connected via an intermediate network to a host computer according to the principles in the present disclosure;

FIG. 5 is a block diagram of a host computer communicating via a network node with a wireless device over an at least partially wireless connection according to some embodiments of the present disclosure;

FIG. 6 is a flow chart illustrating exemplary methods implemented in a communication system including a host computer, a network node and a wireless device for executing a client application at a wireless device according to some embodiments of the present disclosure;

FIG. 7 is a flow chart illustrating exemplary methods implemented in a communication system including a host computer, a network node and a wireless device for receiving user data at a wireless device according to some embodiments of the present disclosure;

FIG. 8 is a flow chart illustrating exemplary methods implemented in a communication system including a host computer, a network node and a wireless device for receiving user data from the wireless device at a host computer according to some embodiments of the present disclosure;

FIG. 9 is a flow chart illustrating exemplary methods implemented in a communication system including a host computer, a network node and a wireless device for receiving user data at a host computer according to some embodiments of the present disclosure;

FIG. 10 is a flowchart of an exemplary process in a network node operating as a master node according to some embodiments of the present disclosure;

FIG. 11 is a flowchart of an alternative exemplary process in a network node operating as a master node according to some embodiments of the present disclosure;

FIG. 12 is a flowchart of an alternative exemplary process in a network node operating as a secondary node according to some embodiments of the present disclosure;

FIG. 13 is a flowchart of an exemplary process in a network node configured to operate as a master node;

FIG. 14 is a flowchart of an alternative exemplary process in a network node operating as a core node according to some embodiments of the present disclosure;

FIG. 15 is a flowchart of an exemplary process in a wireless device for an indication receiver according to some embodiments of the present disclosure;

FIG. 16 is an exemplary flow diagram illustrating an embodiment in accordance with at least some of the principles of the disclosure;

FIG. 17 illustrates an example of an embodiment according to at least some of the principles disclosed herein;

FIG. 18 is a flow diagram of an embodiment according to at least some of the principles disclosed herein;

FIG. 19 is an exemplary flow diagram according to at least some of the principles disclosed herein;

FIG. 20 is still another exemplary flow diagram according to at least some of the principles disclosed herein; and

FIG. 21 is an exemplary flow diagram according to at least some of the principles disclosed herein.

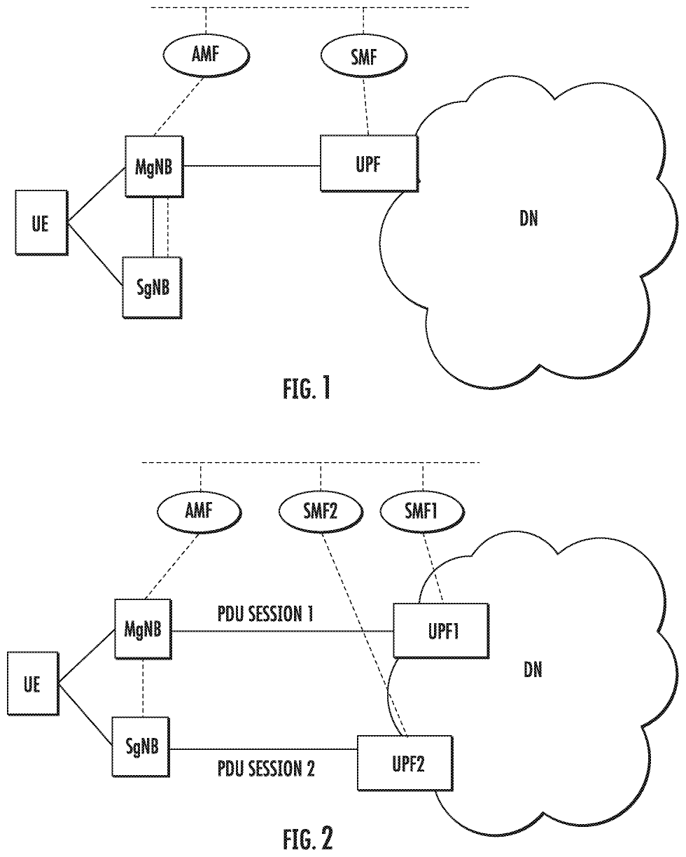

### DETAILED DESCRIPTION

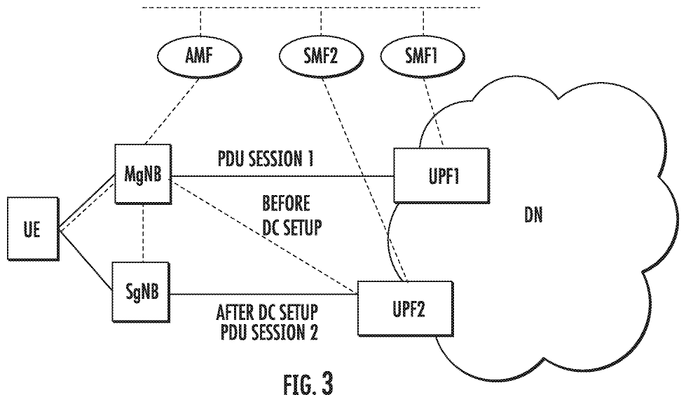

In current dual connectivity wireless communication environments, the identity of the Secondary network node (SgNB) is typically not known in advance until that network node is selected and used. This is suitable for cases where dual connectivity is handled completely in the RAN. However, in cases such as in the redundancy solution described above with reference to FIGS. 2 and 3, for example, the core network may benefit from knowing the identity of the secondary network node, SgNB, to be selected even before dual connectivity is set up.

For example, if the identity of the SgNB to be selected were known after the establishment of PDU Session 1 but before PDU Session 2, a UPF2 could be selected that is better optimized for the actual SgNB selection than may otherwise be selected.

Accordingly, the present disclosure provides a solution whereby the dual connectivity establishment may be split up into at least two phases:

Phase A. The MgNB determines the SgNB to be used for dual connectivity, and the other network entities may be informed about the selected SgNB; and Phase B. The dual connectivity is established at the given SgNB. This phase/step may be triggered by an explicit signaling.

In some embodiments, the SgNB identity may be e.g., the SgNB's Global RAN Node Identity (see e.g., 3GPP TS 38.413v15.2.0), the selected RAN user plane function identity as its IP address if the split RAN architecture utilizing centralized unit-control plane (CU-CP) and CU-UP functionality is used (see e.g., 3GPP TS 38.401v15.2.0), or combination of both or other relevant identifiers.

A benefit of knowing the identity of the SgNB to be selected may be that the core network entities, such as UPF2, can then be selected based on the SgNB identity. This can be used, e.g., for selecting a UPF2 that is close to the SgNB, so that the user plane (UP) path delays can be minimized. This may be useful, particularly for delay critical traffic. Also, selecting UPF2 closer to or even co-sited with SgNB can improve the system reliability as compared with other solutions due to having less and shorter links and nodes that may fail.

Before describing in detail exemplary embodiments, it is noted that the embodiments reside primarily in combinations of apparatus components and processing steps related to advanced secondary network node selection for dual connectivity. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein, such as for example secondary network node or master network node, can be any kind of network node comprised in a radio network which may further comprise any of base station (BS), radio base station, base transceiver station (BTS), base station controller (BSC), radio network controller (RNC), g Node B (gNB) (such as a MgNB and an SgNB), evolved Node B (eNB or eNodeB), Node B, multi-standard radio (MSR) radio node such as MSR BS, multi-cell/multicast coordination entity (MCE), relay node, integrated access and backhaul (IAB) node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Also note that terminology such as eNodeB (eNB)/g Node B (gNB) and UE should be considering non-limiting and does in particular not imply a certain hierarchical relation between the two; in general, “eNB” or “gNB” could be considered as device 1 and “UE” could be considered as device 2, and these two devices communicate with each other over some radio channel.

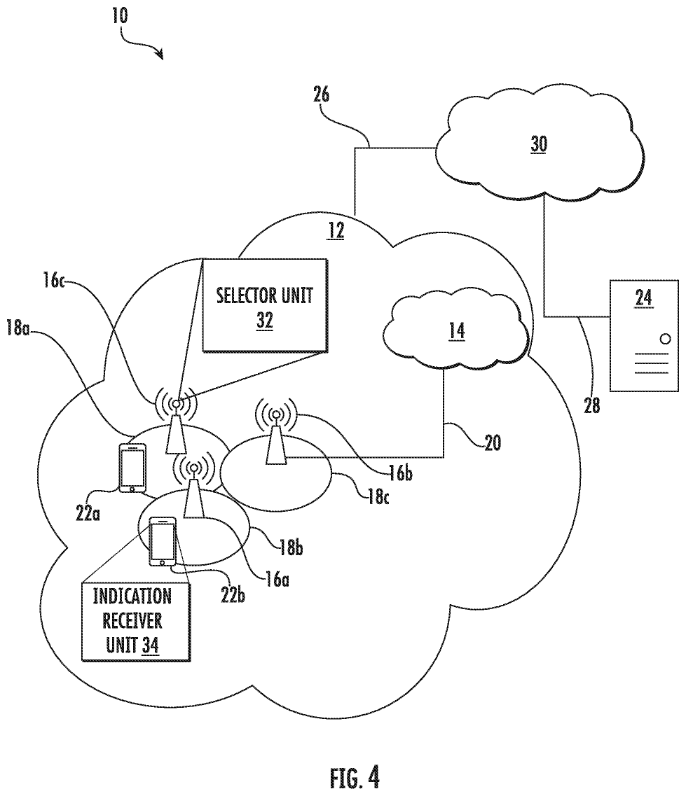

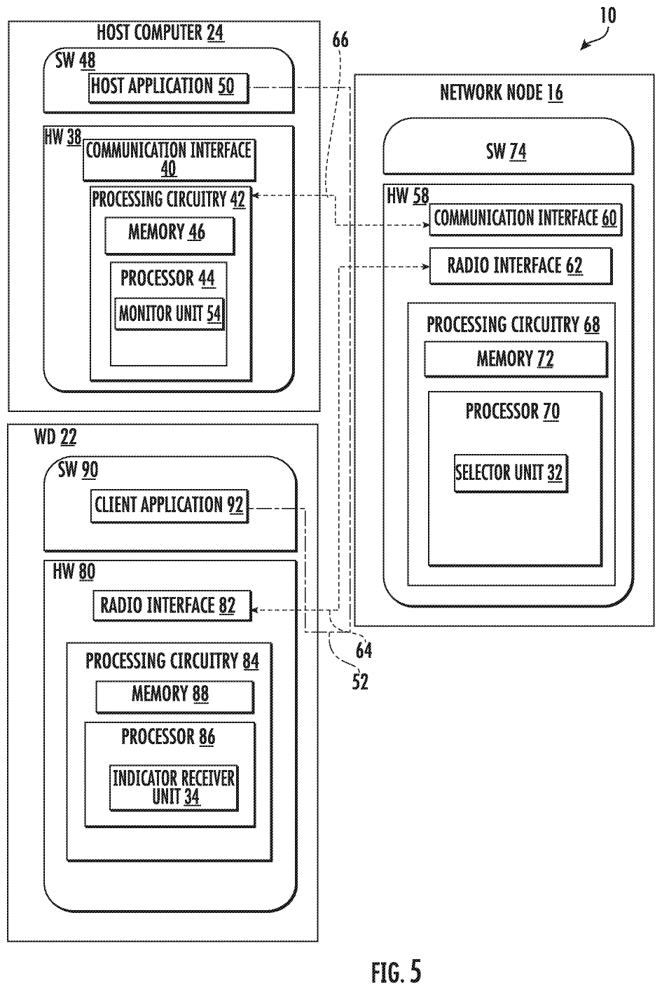

Returning to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. In some embodiments, network node 16a may be a master network node and network node 16b may be a secondary network node. Further, it should be understood that, in practice, a network node 16 may be configured to be able to operate as a master network node for some dual connectivity scenarios and a secondary network node for others. A first wireless device (WD) 22a located in coverage area 18a is configured to wirelessly connect to, or be paged by, the corresponding network node 16c. A second WD 22b in coverage area 18b is wirelessly connectable to the corresponding network node 16a. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 4 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16, such as, for example, a master network node (also referred to herein as MgNB) 16a, may be configured to include a selector unit 32 which is configured, in some embodiments, to receive a selection request, the selection request requesting a selection of a secondary network node 16b for establishing dual connectivity for a wireless device; and responsive to the received selection request, select the secondary network node 16b before establishing dual connectivity for the wireless device; and communicate an indication of the selected secondary network node 16b before establishing dual connectivity for the wireless device 22. In other embodiments, the network node 16 may operate as a master network node and may have the selector unit 32 configured to operate in a pre-dual connectivity phase to select a secondary node for establishing dual connectivity for a wireless device 22 already connected to the master node (the network node 16 in this case), the selecting being before the establishing.

A wireless device 22 is configured to include an indication receiver unit 34 which is configured to, while being connected to a master network node, receive an indication to establish a Protocol Data Unit (PDU) session with a secondary network node 16b for dual-connectivity, the secondary network node 16b being selected before establishing dual connectivity for the wireless device; and perform Random Access (RA) towards the secondary network node 16b for establishing the dual connectivity for the wireless device.

Example implementations, in accordance with an embodiment, of the WD 22, network node 16 and host computer 24 discussed in the preceding paragraphs will now be described with reference to FIG. 5. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to observe, monitor, control, transmit to and/or receive from the network node 16 and/or the wireless device 22.

The communication system 10 further includes a network node 16 provided in a communication system 10 and comprising hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16a may include selector unit 32 which may be configured to: receive a selection request, the selection request requesting a selection of a secondary network node 16b for establishing dual connectivity for a wireless device 22; responsive to the received selection request, select the secondary network node 16b before establishing dual connectivity for the wireless device 22; and communicate an indication of the selected secondary network node 16b before establishing dual connectivity for the wireless device 22. In some embodiments, the selector unit 32 may be configured to operate in a pre-dual connectivity phase to select a secondary node for establishing dual connectivity for a wireless device 22 already connected to the master node, the selecting of the secondary node being before the establishing of the dual connectivity.

In some embodiments, the communication of the indication of the selected secondary network node 16b comprises a communication to a Session Management Function (SMF) for selecting a User Plane Function (UPF) based on the selected secondary network node 16b. In some embodiments, the communication of the indication of the selected secondary network node 16b comprises a communication to another node for selecting at least one network entity for the dual connectivity for the wireless device 22 based on the selected secondary network node 16b. In some embodiments, the processing circuitry 68 is further configured to establish the dual connectivity for the wireless device 22 by establishing a first Protocol Data Unit (PDU) session and a second PDU session via the network node 16a; and releasing the second PDU session with the network node 16a and re-establishing the second PDU session with the secondary network node 16b. In some embodiments, the processing circuitry 68 is further configured to establish a first Protocol Data Unit (PDU) session with the network node 16a for the wireless device 22; and initiate establishment of a second PDU session for the wireless device 22 that comprises the selection of the secondary network node 16b and the communication of the indication of the selected secondary network node 16b before establishing dual connectivity for the wireless device 22. In some embodiments, the first PDU session and the second PDU session are simultaneous PDU sessions for the wireless device 22.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an indicator receiver unit 34 configured to, while being connected to a master network node (e.g., network node 16a), receive an indication to establish a Protocol Data Unit (PDU) session with a secondary network node 16b for dual-connectivity, the secondary network node 16b being selected before establishing dual connectivity for the wireless device 22; and perform Random Access (RA) towards the secondary network node 16b for establishing the dual connectivity for the wireless device 22.

In some embodiments, wherein the indication to establish the PDU session with the secondary network node 16b for dual connectivity is a non-access stratum (NAS) message. In some embodiments, the indication to establish the PDU session with the secondary network node 16b for dual connectivity is a radio resource control (RRC) message. In some embodiments, the processing circuitry 84 is further configured to communicate measurement data to a master network node (e.g., network node 16a) for selection of a secondary network node 16b for dual connectivity.

In some embodiments, the inner workings of the network node 16, WD 22, and host computer 24 may be as shown in FIG. 5 and independently, the surrounding network topology may be that of FIG. 4.

In FIG. 5, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 4 and 5 show various “units” such as selector unit 32, and indication receiver unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

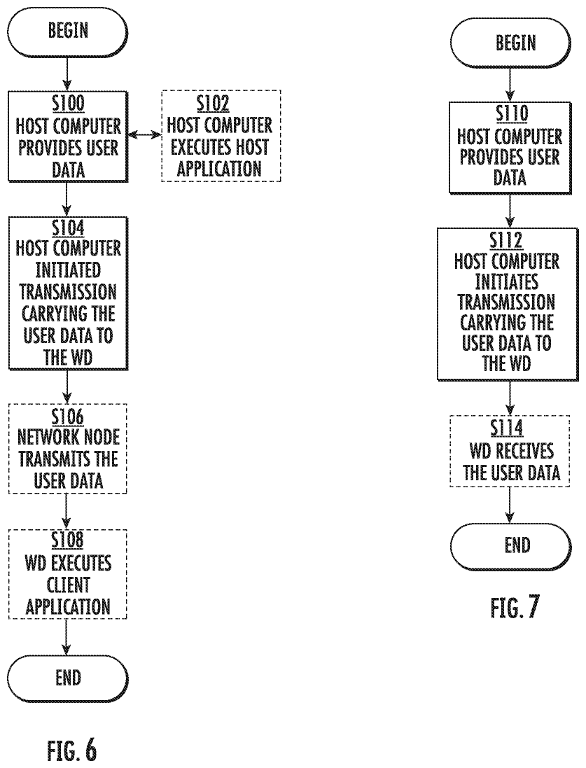

FIG. 6 is a flowchart illustrating an exemplary method implemented in a communication system, such as, for example, the communication system of FIGS. 4 and 5, in accordance with one embodiment. The communication system may include a host computer 24, a network node 16 and a WD 22, which may be those described with reference to FIG. 5. In a first step of the method, the host computer 24 provides user data (block S100). In an optional sub step of the first step, the host computer 24 provides the user data by executing a host application, such as, for example, the host application 50 (block S102). In a second step, the host computer 24 initiates a transmission carrying the user data to the WD 22 (block S104). In an optional third step, the network node 16 transmits to the WD 22 the user data which was carried in the transmission that the host computer 24 initiated, in accordance with the teachings of the embodiments described throughout this disclosure (block S106). In an optional fourth step, the WD 22 executes a client application, such as, for example, the client application 114, associated with the host application 50 executed by the host computer 24 (block S108).

FIG. 7 is a flowchart illustrating an exemplary method implemented in a communication system, such as, for example, the communication system of FIG. 4, in accordance with one embodiment. The communication system may include a host computer 24, a network node 16 and a WD 22, which may be those described with reference to FIGS. 4 and 5. In a first step of the method, the host computer 24 provides user data (block S110). In an optional sub step (not shown) the host computer 24 provides the user data by executing a host application, such as, for example, the host application 50. In a second step, the host computer 24 initiates a transmission carrying the user data to the WD 22 (block S112). The transmission may pass via the network node 16, in accordance with the teachings of the embodiments described throughout this disclosure. In an optional third step, the WD 22 receives the user data carried in the transmission (block S114).

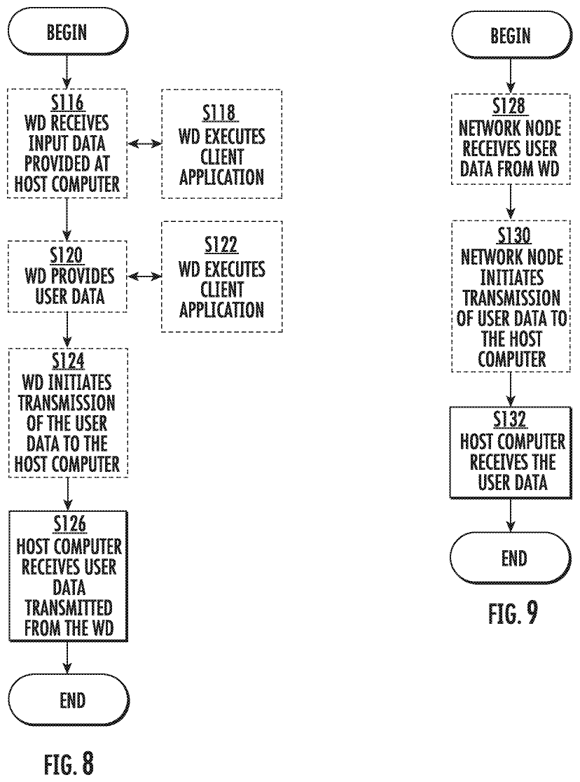

FIG. 8 is a flowchart illustrating an exemplary method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, the WD 22 receives input data provided by the host computer 24 (block S116). In an optional substep of the first step, the WD 22 executes the client application 114, which provides the user data in reaction to the received input data provided by the host computer 24 (block S118). Additionally or alternatively, in an optional second step, the WD 22 provides user data (block S120). In an optional substep of the second step, the WD provides the user data by executing a client application, such as, for example, client application 114 (block S122). In providing the user data, the executed client application 114 may further consider user input received from the user. Regardless of the specific manner in which the user data was provided, the WD 22 may initiate, in an optional third substep, transmission of the user data to the host computer 24 (block S124). In a fourth step of the method, the host computer 24 receives the user data transmitted from the WD 22, in accordance with the teachings of the embodiments described throughout this disclosure (block S126).

FIG. 9 is a flowchart illustrating an exemplary method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, in accordance with the teachings of the embodiments described throughout this disclosure, the network node 16 receives user data from the WD 22 (block S128). In an optional second step, the network node 16 initiates transmission of the received user data to the host computer 24 (block S130). In a third step, the host computer 24 receives the user data carried in the transmission initiated by the network node 16 (block S132).

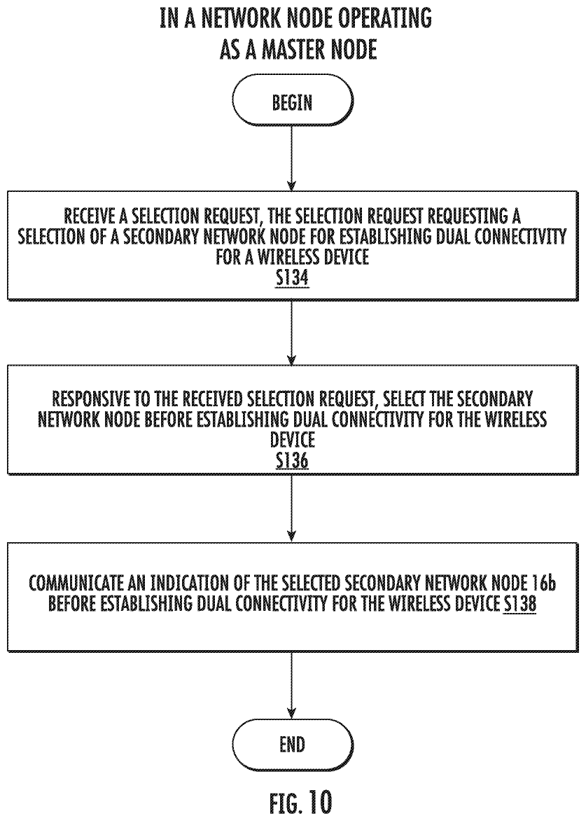

FIG. 10 is a flowchart of an exemplary process in a network node 16 (e.g., network node 16a) for processing a selection request. One or more blocks described herein may be performed by one or more elements of network node 16 such as by one or more of processing circuitry 68 (including the selector unit 32), processor 70, radio interface 62 and/or communication interface 60. Network node 16 such as via processing circuitry 68 and/or processor 70 and/or radio interface 62 and/or communication interface 60 is configured to receive a selection request, the selection request requesting a selection of a secondary network node 16b for establishing dual connectivity for a wireless device 22 (block S134). The process includes, responsive to the received selection request, selecting the secondary network node 16b before establishing dual connectivity for the wireless device 22 (block S136). The process includes communicating an indication of the selected secondary network node 16b before establishing dual connectivity for the wireless device 22 (block S138).

In some embodiments, the communication of the indication of the selected secondary network node 16b comprises a communication to a Session Management Function (SMF) for selecting a User Plane Function (UPF) based on the selected secondary network node 16b. In some embodiments, the communication of the indication of the selected secondary network node 16b comprises a communication to another node for selecting at least one network entity for the dual connectivity for the wireless device 22 based on the selected secondary network node 16b. In some embodiments, the process further includes establishing the dual connectivity for the wireless device 22 by establishing a first Protocol Data Unit (PDU) session and a second PDU session via the network node 16a; and releasing the second PDU session with the network node 16a and re-establishing the second PDU session with the secondary network node 16b. In some embodiments, the process further includes establishing a first Protocol Data Unit (PDU) session with the network node 16a for the wireless device 22; and initiating establishment of a second PDU session for the wireless device 22 that comprises the selection of the secondary network node 16b and the communication of the indication of the selected secondary network node 16b before establishing dual connectivity for the wireless device 22. In some embodiments, the first PDU session and the second PDU session are simultaneous PDU sessions for the wireless device 22.

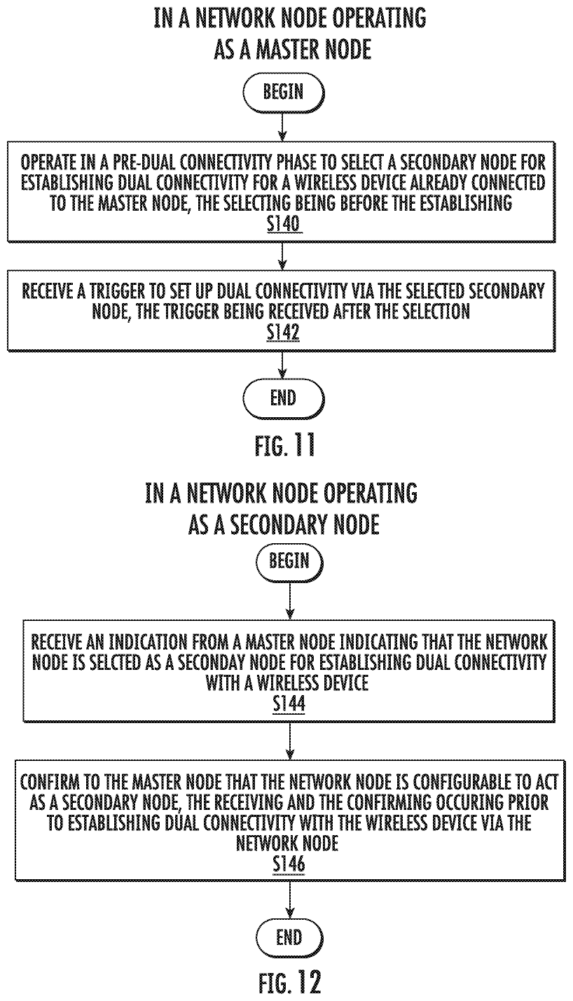

FIG. 11 is a flowchart of an alternative exemplary process in a network node 16 operating as a master node according to some embodiments of the present disclosure. The process includes operating in a pre-dual connectivity phase to select a secondary node for establishing dual connectivity for a wireless device, the selecting being before the establishing (block S140). The process also includes receiving a trigger to set up dual connectivity via the selected secondary node, the trigger being received after the selection (block S142). The process steps of FIG. 11 may be performed in whole or in part by the processing circuitry 68.

FIG. 12 is a flowchart of an alternative exemplary process in a network node 16 operating as a secondary node according to some embodiments of the present disclosure. The process includes receiving an indication from a master node indicating that the network node 16 is selected as a secondary node for establishing dual connectivity with a wireless device (block S144). The process also includes confirming to the master node that the network node 16 is configurable to act as a secondary node, the receiving and the confirming occurring prior to establishing dual connectivity with the wireless device via the network node 16 (block S146). The process steps of FIG. 12 may be performed in whole or in part by the processing circuitry 68.

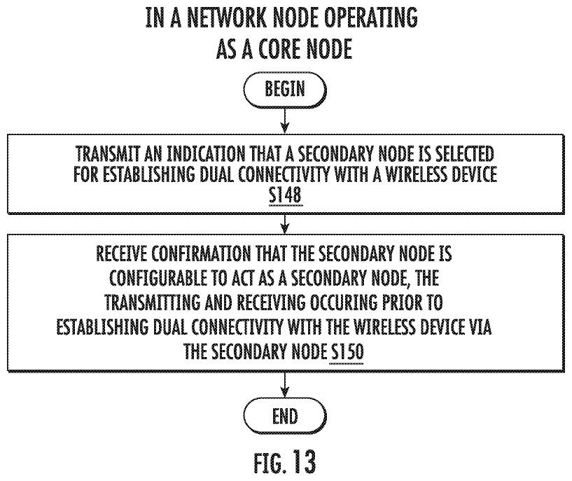

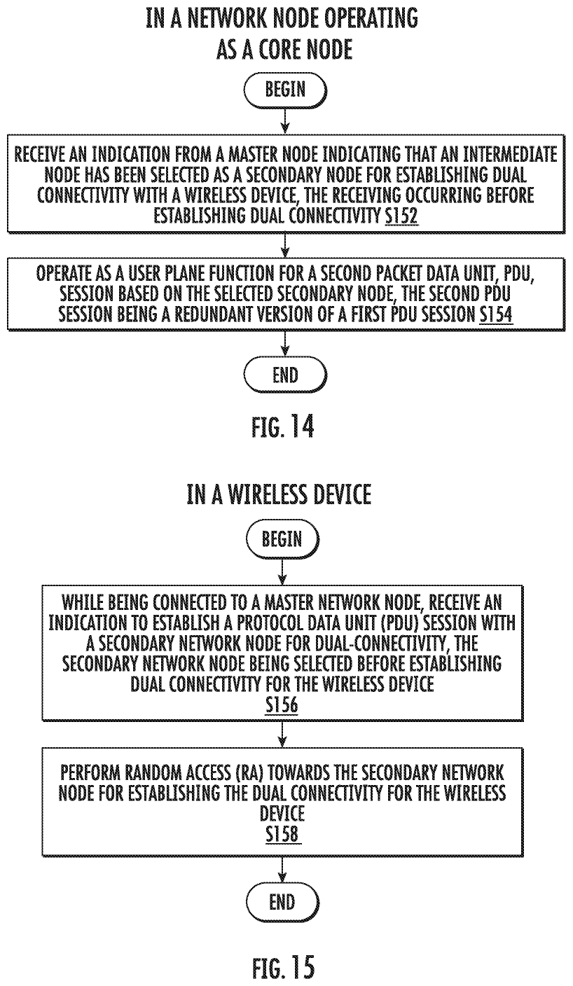

FIG. 13 is a flowchart of an exemplary process in a network node 16 configured to operate as a master node. The process includes transmitting an indication that a secondary node is selected for establishing dual connectivity with a wireless device 22 (block S148), and receiving confirmation that the secondary node is configurable to act as a secondary node, the transmitting and receiving occurring prior to establishing dual connectivity with the wireless device via the secondary node (block S150).

FIG. 14 is a flowchart of an alternative exemplary process in a network node 16 operating as a core node according to some embodiments of the present disclosure. The process includes receiving an indication from a master node indicating that an intermediate node has been selected as a secondary node for establishing dual connectivity with a wireless device, the receiving occurring before establishing dual connectivity (block S152). The process also includes operating as a user plane function for a second packet data unit, PDU, session based on the selected secondary node, the second PDU session being a redundant version of a first PDU session (block S154). The process steps of FIG. 13 may be performed in whole or in part by the processing circuitry 68.

FIG. 15 is a flowchart of an exemplary process in a wireless device 22 according to some embodiments of the present disclosure. One or more blocks described herein may be performed by one or more elements of wireless device 22 such as by one or more of processing circuitry 84 (including the indicator receiver unit 34), processor 86, radio interface 82 and/or communication interface 60. Wireless device 22 such as via processing circuitry 84 and/or processor 86 and/or radio interface 82 is configured to, while being connected to a master network node (e.g., network node 16a), receive an indication to establish a Protocol Data Unit (PDU) session with a secondary network node 16b for dual-connectivity, the secondary network node 16b being selected before establishing dual connectivity for the wireless device 22 (block S156). The process includes performing Random Access (RA) towards the secondary network node 16b for establishing the dual connectivity for the wireless device 22 (block S158). In some embodiments, the indication to establish the PDU session with the secondary network node 16b for dual connectivity is a non-access stratum (NAS) message. In some embodiments, the indication to establish the PDU session with the secondary network node 16b for dual connectivity is a radio resource control (RRC) message. In some embodiments, the process further includes communicating measurement data to a master network node (e.g., network node 16a) for selection of a secondary network node 16b for dual connectivity. Having generally described some embodiments of the present disclosure, a more detailed description of some of the embodiments will now be described below.

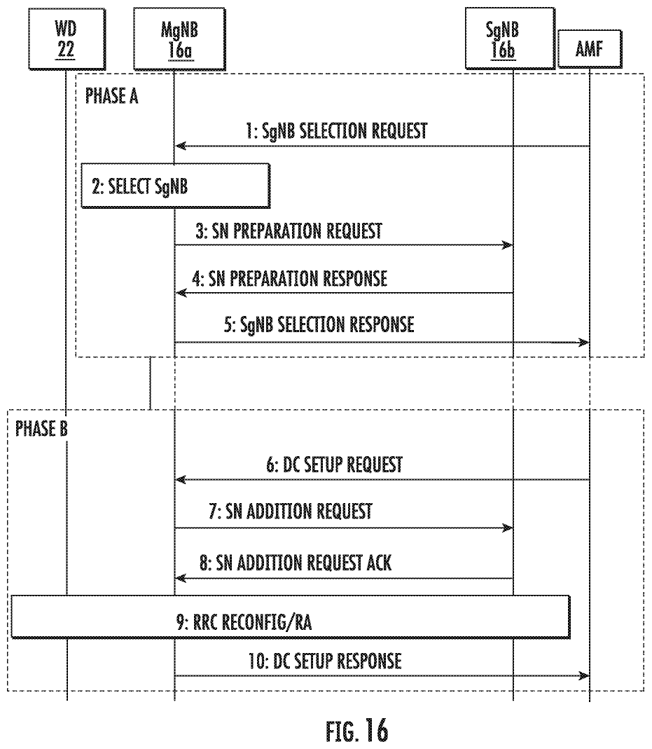

An example of a solution provided by the present disclosure can be seen in FIG. 16. Note that some of the steps are optional as explained below.

In Phase A, the selection of the secondary network node 16b (e.g., SgNB) is performed without actually setting up dual connectivity.

Step 1 of FIG. 16: A secondary network node 16b selection request trigger arrives to the master network node 16a (e.g., MgNB). This message may originate from the Access and Mobility Function (AMF), or from other network entities, or from the WD 22. It may be possible that this is not a separate message, but another already existing message serves as the trigger for the secondary network node 16b selection.

Step 2 of FIG. 16: The secondary network node 16b is selected, by e.g., the processing circuitry 68 of master network node 16a, based on information available at the master network node 16a. The information may relate to measurements received from the WD on different cells, the cell identity and the identity of the radio node that provides the cell. This selection may take time and may also involve the collection of WD 22 measurement data (not shown in the figure) regarding the potential secondary network nodes 16b and the corresponding link quality. Example of additional information that may also be used is the evaluation of the load in potential target nodes. Assistance information could be based on statistics collected by master network node 16a and available in the master network node 16a or in another node or Network Function (NF) that can be part of the RAN or Core Network (CN) or shared between both.

Steps 3-4 of FIG. 16: The master network node 16a may, such as, for example, via processing circuitry 68, request the selected secondary network node 16b to confirm whether it is willing to act as a secondary network node 16b for the given WD 22 depending on the current radio conditions and load, and the secondary network node 16b provides a response on its willingness. The master network node 16a may, such as, for example, via processing circuitry 68, provide additional information in the preparation request, such as, for example, radio resource control (RRC) parameters, including WD 22 Radio Access Capability information, security parameters, radio bearer information (e.g., Quality-of-service (QoS) profile, see TS 23.501v15.2.0) or other to helpful information to the secondary network node 16b to determine whether dual connectivity can be established. The secondary network node 16b may also store the information to prepare the dual connectivity setup. In such cases, the same information might not need to be provided again by the master network node 16a. However, the dual connectivity will not yet be activated, as no radio bearers will be served at the secondary network node 16b yet, as Phase A. If the secondary network node 16b is not ready to accept the WD 22, the master network node 16a may, such as, for example, via processing circuitry 68, select another secondary network node 16b, or the master network node 16a may, such as, for example, via processing circuitry 68, also ask the same secondary network node 16b later on when the radio and/or load conditions may be changed. This step is optional and may be skipped. If it is skipped, the master network node 16a assumes that the secondary network node 16b will most likely accept the WD 22 when dual connectivity is requested. To increase the robustness, master network node 16a may, such as, for example, via processing circuitry 68, select and prepare multiple target secondary network node 16b candidates and then choose among the available secondary network node 16b candidates.

Step 5 in FIG. 16: The secondary network node 16b selection (or the selection of the cell at the secondary network node 16b) is indicated to other entities. In this example, the secondary network node 16b selection is indicated to the AMF, but the AMF may forward this information further or it may be forwarded transparently, e.g., to the Session Management Function (SMF). The indication may be performed towards other network entities as well, and may be combined with other, existing messages. In some embodiments, the indication in this step may be performed to a different network entity compared to the one that made the trigger in step 1. In some embodiments, the indication may be sent multiple times, e.g. as part of multiple existing messages. In case a suitable secondary network node 16b could not be selected by the master network node 16a, this can also be indicated in a message.

In cases where the radio conditions no longer allow the same secondary network node 16b to be used as selected in step 2 and indicated in step 5, the master network node 16a may eventually re-select a different secondary network node 16b than what was originally selected in step 2. Optionally, it may be possible for the master network node 16a to indicate the change of the selected secondary network node 16b, using a repetition of steps 2-5 of FIG. 12.

In Phase B, the actual dual connectivity setup is performed. There may be some time between when Phase A finishes and when Phase B starts.

Step 6 in FIG. 16: An explicit trigger is provided by AMF to set up dual connectivity. Note that, in some embodiments, this step may come from other sources than the AMF, and or may come from an original source via the AMF. This trigger may also be combined with an existing message. Alternatively, the trigger may be internal in the master network node 16a, or may be timed or user plane activity based.

Steps 7-9 in FIG. 16: Dual connectivity is set up using signaling to the secondary network node 16b, and an indication is sent to the WD 22, which performs Random Access (RA) at the secondary network node 16b. An example of details for the establishment of the dual connectivity set up of steps 7-9 are defined, for example, in 3GPP TS 37.340v15.2.0 section 10.2.

In cases where the radio conditions no longer allow the same secondary network node 16b to be used as selected in step 2, the master network node 16a may eventually use a different secondary network node 16b than was originally selected in step 2.

Step 10 of FIG. 16: The successful establishment of dual connectivity may be indicated e.g., to the AMF. The identity of the secondary network node 16b (or the selected cell) may also be indicated. This step may use a new message or it may be part of an existing message, such as a Path Switch Request.

A number of example embodiments showing how some solutions described herein can be applied for the establishment of redundant PDU Sessions are discussed below.

Release and re-establishment of a PDU Session for redundancy based on dual connectivity

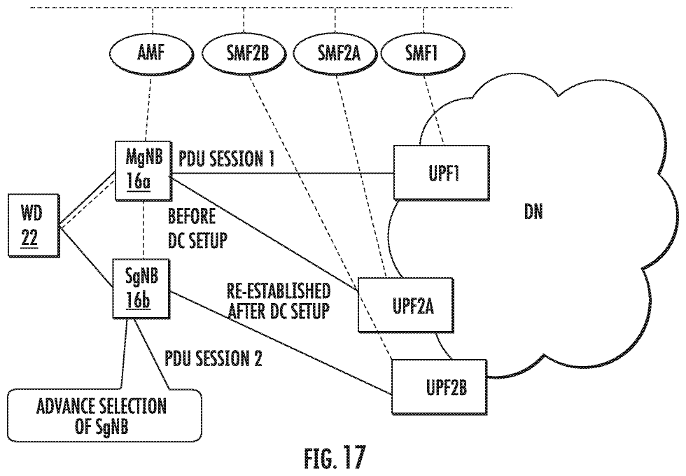

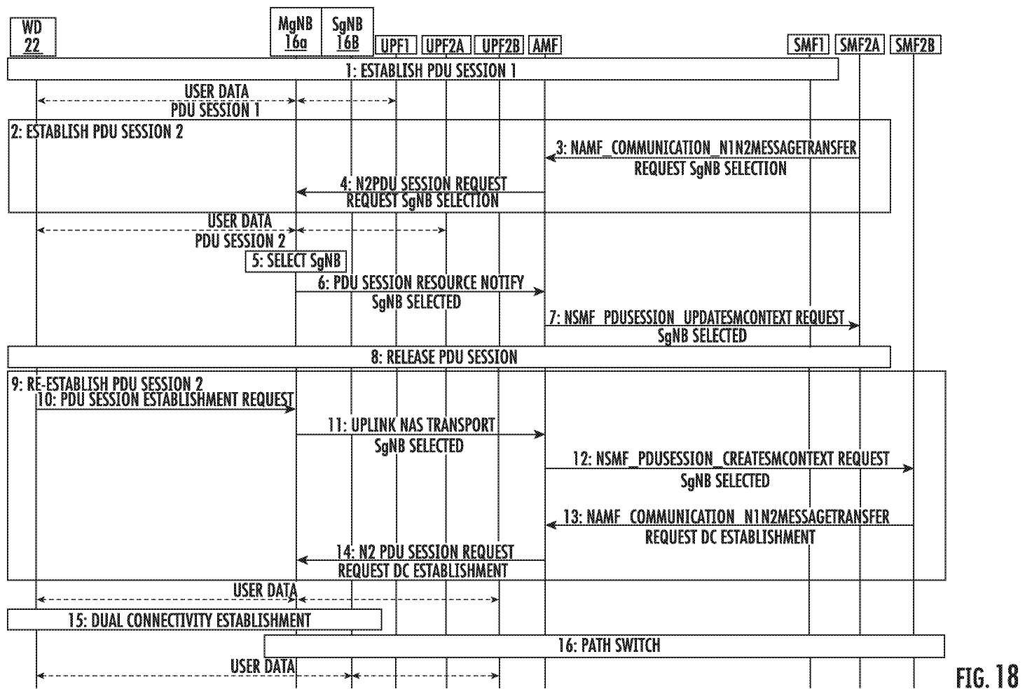

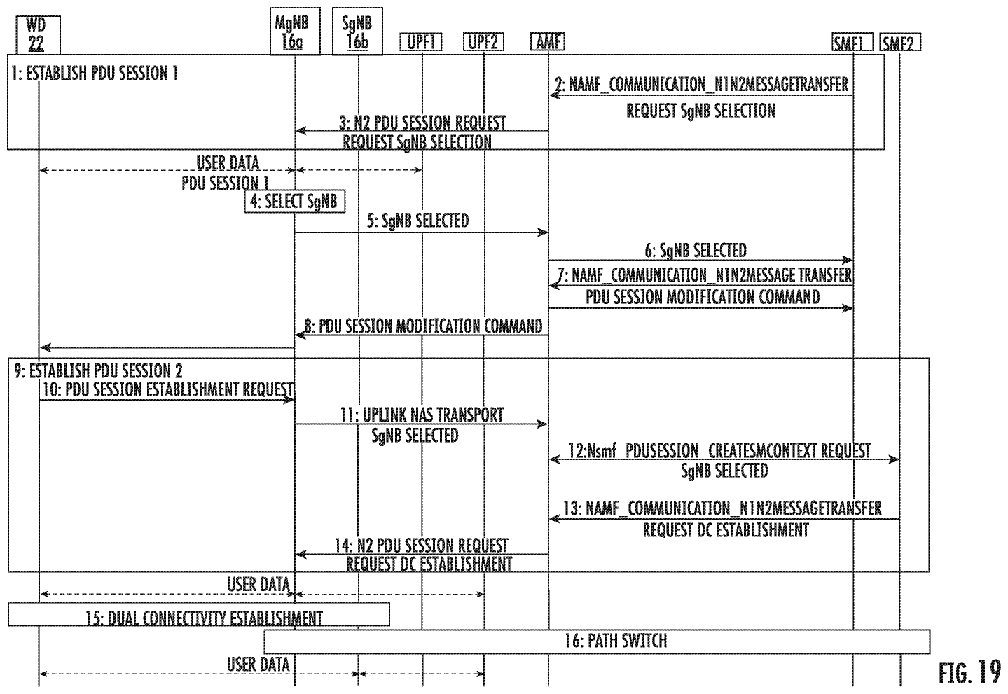

This embodiment establishes a second PDU session for a given WD 22 that is redundant to a first PDU Session. In the RAN, the redundancy in the user plane is provided using dual connectivity. In the core network, the UPF should be selected for the second PDU session based on the selected secondary network node 16b. In one embodiment, the UPF could be selected that is relatively close to the secondary network node 16b. As shown in FIG. 17, the second PDU Session may be originally established via the master network node 16a; however, once the secondary network node 16b is selected in RAN, the second PDU Session may be released and re-established, as described in more detail in FIG. 18.

Step 1 in FIG. 18: The first PDU Session is established according to, for example, 3GPP TS 23.502v15.2.0 section 4.3.2.2. The user plane is via the master network node 16a and the selected UPF1.

Steps 2-4 in FIG. 18: The second PDU Session is established (only some selected messages are shown of the PDU Session establishment process). As part of the second PDU Session establishment, an indication may be sent from the SMF to the AMF and forwarded on from the AMF to the master network node 16a, to select a secondary network node 16b for dual connectivity. (This may be combined with other indications, indicating to the master network node 16a to use dual connectivity-based redundancy in RAN for the two PDU Sessions).

After the PDU Session establishment, the user plane goes via the master network node 16a and the selected UPF2A. The radio connection with the WD is just with a single network node and that is here referred to as the master network node 16a.

Step 5 in FIG. 18: The master network node 16a selects secondary network node 16b in advance, before establishing dual connectivity.

Step 6 of FIG. 18: The selection of the secondary network node 16b (or the associated cell) is signaled to the AMF. This may be performed e.g., as part of the PDU session resource notify message.

Step 7 of FIG. 18: The selection of the secondary network node 16b (or the associated cell) is signaled from the AMF to the SMF. This may be performed, e.g., as part of modifying the session parameters.

Step 8 of FIG. 18: The SMF may decide to release the PDU Session with an indication to the WD 22 to re-establish it. This may be performed in order to be able to select a new UPF that is closer (or better suited to) the selection of secondary network node 16b in RAN. The SMF may make the determination (based on operator configuration, or e.g. by a machine learning approach) whether the current UPF is suitable for the selected secondary network node 16b, or whether a different UPF should be selected after re-establishing the PDU Session.

Steps 9-12 of FIG. 18: The PDU Session is re-established (only some messages are shown). As part of the PDU Session Establishment process, the Uplink Non-access stratum (NAS) transport message over the N2 interface may carry the selected secondary network node 16b (or the corresponding cell) identity, as indicated in FIG. 14. Note that the master network node 16a may append this information to any uplink NAS message, or other N2 messages as well, as the master network node 16a may not know which message processing would require the information (master network node 16a may not be able to read the NAS message). The selected secondary network node 16b information may be transferred from the AMF to the SMF in an existing signaling message. The new SMF (which might not be the same as the SMF used earlier) selects a new UPF based on the information that the given secondary network node 16b is selected in RAN for dual connectivity.

Steps 13-14 of FIG. 18. Also, as part of the PDU Session re-establishment, the SMF indicates to the master network node 16a via the AMF that dual connectivity should be established for the given PDU Session. After the PDU Session establishment, the user plane goes via the master network node 16a and the newly selected UPF.

Step 15 of FIG. 18: Dual connectivity may be established in the RAN, for example, as defined, in 3GPP TS 37.340v15.2.0 section 10.2.

Step 16 of FIG. 18: The path is switched to the secondary network node 16b, for example, as defined in 3GPP TS 23.502v15.2.0 section 4.9.1.2.2. After that, the user plane path of the second PDU session goes via the secondary network node 16b and UPF2B which was selected based on the identity of the secondary network node 16b.

Deferred Setup of Second PDU Session Until Secondary Network Node is Selected

This embodiment establishes a second PDU session for a given WD 22 that is redundant to a first PDU Session. In the RAN, the redundancy in the user plane is provided using dual connectivity. In some embodiments, in the core network, the UPF may be selected for the second PDU session based on the selected secondary network node 16b, so that, for example, the UPF could be selected close to the secondary network node 16b. The establishment of the second PDU Session from the WD 22 may be deferred and triggered only when the secondary network node 16b is selected.

An example of the solution is illustrated in FIG. 19.

Steps 1-3 of FIG. 19: The first PDU Session is established (only a few selected messages are shown). Knowing (based on network configuration or WD 22 indication) that two PDU sessions are going to be established for redundancy, the SMF requests RAN to select the secondary network node 16b. An indication for that is sent from the SMF to the AMF and on to the master network node 16a. After the PDU Session establishment, the user plane goes via master network node 16a and UPF1.

Step 4 of FIG. 19: The master network node 16a selects secondary network node 16b in advance, before establishing dual connectivity.

Step 5 of FIG. 19: The selection of the secondary network node 16b (or the associated cell) is signaled to the AMF. This may be performed e.g., as part of the PDU session resource notify message.

Step 6 of FIG. 19: The selection of the secondary network node 16b (or the associated cell) is signaled from the AMF to the SMF. This may be performed e.g., as part of modifying the session parameters.

Step 7-8 of FIG. 19: The SMF may trigger the WD 22 to establish the second PDU Session. Given that the secondary network node 16b is selected, the second PDU session can now be established knowing the secondary network node 16b. The trigger for establishing the second PDU Session can be sent to the WD 22 as a NAS message (with a new parameter indicating the trigger, e.g., in the PDU Session Modification command from the SMF to the AMF to the master network node 16a to the WD 22). Note that the trigger could be sent to the WD 22 in other ways as well, e.g. as a Radio Resource Control (RRC) message directly after step 4.

Steps 9-12 of FIG. 19: The Second PDU Session is established (only selected messages are shown). As part of the PDU Session Establishment process, the Uplink NAS transport message over the N2 interface may carry the selected secondary network node 16b (or the corresponding cell) identity. Note that the master network node 16a may append this information to any uplink NAS message, or other N2 messages as well, as the master network node 16a may not know which message processing would require the information (master network node 16a cannot read the NAS message). The Selected secondary network node 16b information is transferred from the AMF to the SMF in an existing signaling message. The new SMF (which might not be the same as the SMF used earlier) selects a new UPF based on the information that the given secondary network node 16b is selected in RAN for dual connectivity. FIG. 19 illustrates the exemplary process with the SMF2 being not the same as the SMF1 used earlier. For the sake of completeness, FIG. 17 illustrates the SMF2 used earlier (in steps 7-8) being the same as the SMF2 establishing PDU session 2 but is otherwise the same as FIG. 19.

Steps 13-14 of FIG. 19: Also, as part of the PDU Session establishment, the SMF indicates to the master network node 16a via the AMF that dual connectivity should be established for the given PDU Session. After the PDU Session establishment, the user plane goes via the master network node 16a and the newly selected UPF.

Step 15 of FIG. 19: Dual connectivity is established in the RAN, for example, as defined in 3GPP TS 37.340v15.2.0 section 10.2.

Step 16 of FIG. 19: The path is switched to the secondary network node 16b, for example, as defined in 3GPP TS 23.502v15.2.0 section 4.9.1.2.2. After that, the user plane path of the second PDU session goes via the secondary network node 16b and UPF2 which was selected based on the identity of the secondary network node 16b.

Secondary Network Node Selection During PDU Session Establishment

This embodiment provides PDU Session Establishment where the SMF can select the UPF based on the secondary network node 16b identity. For this purpose, the secondary network node 16b is selected in RAN within the PDU Session Establishment procedure, so that, for example, the SMF can consider the secondary network node 16b selection even within the PDU Session Establishment procedure.

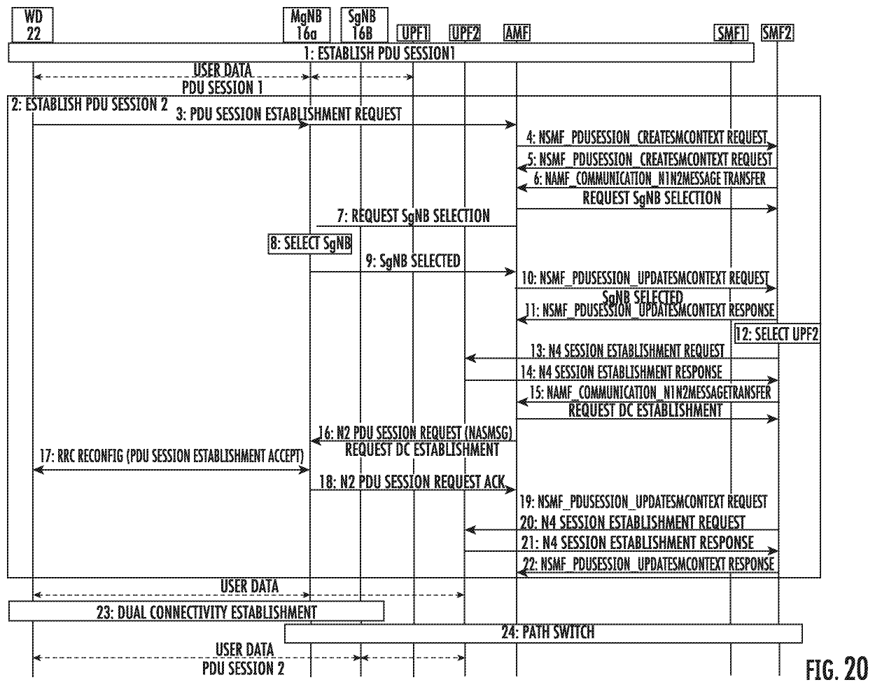

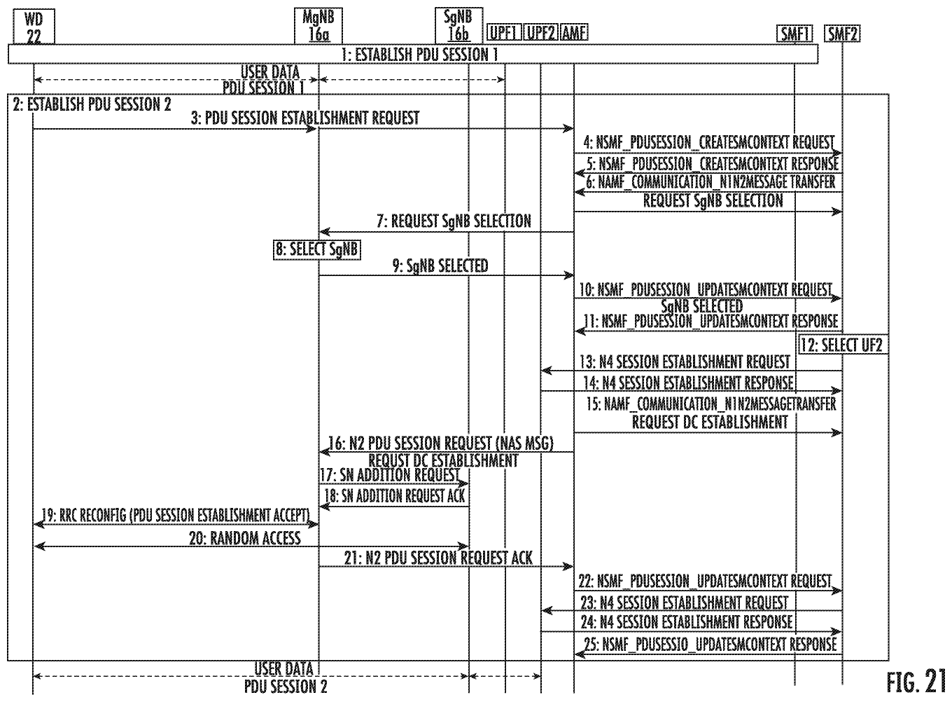

An example of the solution is illustrated in FIG. 20.

Step 1 of FIG. 20: The first PDU Session is established. After the PDU Session establishment, the user plane goes via master network node 16a and UPF1.

Steps 2-5 of FIG. 20: The Second PDU Session establishment is started. The WD's 22 request is forwarded from the AMF to the SMF and acknowledged.

Steps 6-7 of FIG. 20: Knowing that this is a second, redundant PDU Session establishment, the SMF requests RAN via signaling through the AMF to select a secondary network node 16b for dual connectivity. The message from the AMF to the master network node 16a may be a new message or may be incorporated into an existing message type such as, for example, WD Context Modification Request.

Step 8 of FIG. 20: The master network node 16a selects a secondary network node 16b for dual connectivity. This may take some time, depending on the availability of WD 22 measurement reports of other cells.

Steps 9-11 of FIG. 20: The selected secondary network node 16b (or the corresponding cell) is reported to the AMF and then to the SMF, with a possible acknowledgement.

Step 12 of FIG. 20: The SMF selects a UPF considering the identity of the secondary network node 16b (or the corresponding cell). This can ensure that a close UPF is selected.

Steps 13-22 of FIG. 20: The rest of the PDU Session Establishment process is executed. After this, the user plane goes via the master network node 16a and the selected UPF2.

Step 23 of FIG. 20: Dual connectivity is established in RAN, for example, as defined in 3GPP TS 37.340v15.2.0 section 10.2.

Step 24 of FIG. 20: The path is switched to the secondary network node 16b, for example, as defined in 3GPP TS 23.502v15.2.0 section 4.9.1.2.2. After that, the user plane path of the second PDU session goes via the secondary network node 16b and UPF2 which was selected based on the identity of the secondary network node 16b.

Another variant of the procedures in the present disclosure is possible, as shown in FIG. 21. The difference is that in the below variant of FIG. 21, the establishment of dual connectivity takes place within the PDU Session Establishment procedure, not afterwards, so that the establishment of dual connectivity and the corresponding path switch after the session is established are avoided.

Steps 1-16 are executed as described above, with reference to FIG. 20. The difference is that the master network node 16a establishes dual connectivity (DC) within the PDU Session Establishment procedure. In steps 17-18 of FIG. 21, the selected secondary network node 16b is added. In step 19 of FIG. 21, the master network node 16a performs reconfiguration for both the secondary network node 16b addition and the PDU Session Establishment Accept simultaneously. (In practice this step may constitute several RRC message interactions between the master network node 16a and the WD 22). In step 21 of FIG. 21, the WD 22 performs random access procedure at the secondary network node 16b and any possible additional steps needed for the establishment of dual connectivity. In step 21 of FIG. 21, (which may take place in parallel to step 20), the session request is acknowledged. The rest of the procedure takes place normally for the PDU Session Establishment.

Thus, some embodiments of the present disclosure break up the dual connectivity establishment into at least two main phases: in the first phase, a node within the RAN selects the secondary network node 16b (or the corresponding cell) and the selection is communicated to other network entities, without actually setting up the data bearers via the secondary network node 16b. This allows other network entities to perform tasks that are dependent on the secondary network node 16b selection, such as e.g., UPF selection. Once these other tasks are completed, a node with the RAN may then be instructed to actually establish dual connectivity for the WD 22.

As used herein, in some embodiments, the term “simultaneous” is used and may be used to indicate that a first PDU session with a first network node partially overlaps in time, for the same WD, with a second PDU session with a second network node, the second network node being different from the first network node.

Any two or more embodiments described in this disclosure may be combined in any way with each other.

It should be understood that the flow diagrams above may omit steps, messages, and/or nodes, for the sake of clarity.

An indication (e.g., an indication of a secondary network node, etc.) generally may explicitly and/or implicitly indicate the information it represents and/or indicates. Implicit indication may for example be based on position and/or resource used for transmission.

Explicit indication may for example be based on a parametrization with one or more parameters, and/or one or more index or indices corresponding to a table, and/or one or more bit patterns representing the information. In one embodiment, the indication may be and/or include an identity of the secondary network node.

According to one aspect, a network node 16 configured to operate as a master node is provided. The network node 16 includes processing circuitry 68 configured to: operate in a pre-dual connectivity phase to select a secondary node for establishing dual connectivity for a wireless device 22, the selecting being before the establishing, and receive a trigger to set up dual connectivity via the selected secondary node, the trigger being received after the selection.

According to this aspect, in some embodiments, the selecting is based on statistics collected by the network node 16. In some embodiments, the network node 16 also includes a radio interface configured to communicate an indication of the selected secondary node before establishing dual connectivity for the wireless device 22. In some embodiments, the communication of the indication of the selected secondary node comprises a communication to a Session Management Function, SMF, for selecting a User Plane Function, UPF, based on the selected secondary node. In some embodiments, the communication of the indication of the selected secondary node enables associating at least one core node to the selected secondary node, the at least one core node being used to establish dual connectivity to the wireless device 22 via the secondary node. In some embodiments, the processing circuitry 68 is further configured to establish the dual connectivity for the wireless device 22 by: establishing a first Protocol Data Unit, PDU, session and a second PDU session via the network node 16; and releasing the second PDU session with the network node 16 and re-establishing the second PDU session with the secondary node. In some embodiments, the first PDU session and the second PDU session are simultaneous PDU sessions for the wireless device 22.

According to another aspect, a method in a network node 16 configured to operate as a master node is provided. The method includes operating in a pre-dual connectivity phase to select a secondary node for establishing dual connectivity for a wireless device 22, the selecting being before the establishing. The method also includes receiving a trigger to set up dual connectivity via the selected secondary node, the trigger being received after the selection.

According to this aspect, in some embodiments, the selecting is based on statistics collected by the network node 16. In some embodiments, the method further includes communicating an indication of the selected secondary node before establishing dual connectivity for the wireless device 22. In some embodiments, the communication of the indication of the selected secondary node comprises a communication to a Session Management Function, SMF, for selecting a User Plane Function, UPF, based on the selected secondary node. In some embodiments, the communication of the indication of the selected secondary node enables associating at least one core node to the selected secondary node, the at least one core node being used to establish dual connectivity to the wireless device 22 via the secondary node. In some embodiments, the processing circuitry 68 is further configured to establish the dual connectivity for the wireless device 22 by: establishing a first Protocol Data Unit, PDU, session and a second PDU session via the network node 16; and releasing the second PDU session with the network node 16 and re-establishing the second PDU session with the secondary node. In some embodiments, the first PDU session and the second PDU session are simultaneous PDU sessions for the wireless device 22.

According to yet another aspect, a network node 16 configured to operate as a secondary node is provided. The network node 16 includes processing circuitry 68 configured to: receive an indication from a master node indicating that the network node 16 is selected as a secondary node for establishing dual connectivity with a wireless device 22; and confirm to the master node that the network node 16 is configurable to act as a secondary node, the receiving and the confirming occurring prior to establishing dual connectivity with the wireless device 22 via the network node 16. In some embodiments, the processing circuitry 68 is further configured to determine whether the network node 16 is configurable to act as a secondary node based on information received in the indication.

According to another aspect, a method in a network node 16 configured to operate as a secondary node is provided. The method includes receiving an indication from a master node indicating that the network node 16 is selected as a secondary node for establishing dual connectivity with a wireless device 22. The method also includes confirming to the master node that the network node 16 is configurable to act as a secondary node, the receiving and the confirming occurring prior to establishing dual connectivity with the wireless device 22 via the network node 16. In some embodiments, the method further includes determining whether the network node 16 is configurable to act as a secondary node based on information received in the indication.

According to yet another aspect, a network node 16 is configured to operate as a master node. The network node 16 includes processing circuitry 68 configured to transmit an indication that a secondary node is selected for establishing dual connectivity with a wireless device, and receive confirmation that the secondary node is configurable to act as a secondary node, the transmitting and receiving occurring prior to establishing dual connectivity with the wireless device 22 via the secondary node.

According to another aspect, a method in a network node (16) configured to operate as a master node is provided. The method includes transmitting an indication that a secondary node is selected for establishing dual connectivity with a wireless device, and receiving confirmation that the secondary node is configurable to act as a secondary node, the transmitting and receiving occurring prior to establishing dual connectivity with the wireless device via the secondary node.

According to yet another aspect, network node 16 configured to operate as a core node is provided. The network node 16 includes processing circuitry 68 configured to: receive an indication from a master node indicating that an intermediate node has been selected as a secondary node for establishing dual connectivity with a wireless device 22, the receiving occurring before establishing dual connectivity; and operate as a user plane function for a second packet data unit, PDU, session based on the selected secondary node, the second PDU session being a redundant version of a first PDU session.

According to another aspect. method in a network node 16 is configured to operate as a core node. The method includes receiving an indication from a master node indicating that an intermediate node has been selected as a secondary node for establishing dual connectivity with a wireless device 22, the receiving occurring before establishing dual connectivity. The method further includes operating as a user plane function for a second packet data unit, PDU, session based on the selected secondary node, the second PDU session being a redundant version of a first PDU session.

Some embodiments include the following:

Embodiment A1. A network node configured to communicate with a wireless device (WD), the network node configured to, and/or comprising a radio interface and/or comprising processing circuitry configured to:

receive a selection request, the selection request requesting a selection of a secondary network node for establishing dual connectivity for a wireless device;

responsive to the received selection request, select the secondary network node before establishing dual connectivity for the wireless device; and

communicate an indication of the selected secondary network node before establishing dual connectivity for the wireless device.

Embodiment A2. The network node of Embodiment A1, wherein the communication of the indication of the selected secondary network node comprises a communication to a Session Management Function (SMF) for selecting a User Plane Function (UPF) based on the selected secondary network node.

Embodiment A3. The network node of Embodiment A1, wherein the communication of the indication of the selected secondary network node comprises a communication to another node for selecting at least one network entity for the dual connectivity for the wireless device based on the selected secondary network node.

Embodiment A4. The network node of any one of Embodiments A1-A3, wherein the processing circuitry is further configured to establish the dual connectivity for the wireless device by:

establishing a first Protocol Data Unit (PDU) session and a second PDU session via the network node; and

releasing the second PDU session with the network node and re-establishing the second PDU session with the secondary network node.

Embodiment A5. The network node of any one of Embodiments A1-A3, wherein the processing circuitry is further configured to:

establish a first Protocol Data Unit (PDU) session with the network node for the wireless device; and

initiate establishment of a second PDU session for the wireless device that comprises the selection of the secondary network node and the communication of the indication of the selected secondary network node before establishing dual connectivity for the wireless device.

Embodiment A6. The network node of any one of Embodiments A4 and A5, wherein the first PDU session and the second PDU session are simultaneous PDU sessions for the wireless device.

Embodiment B 1. A method implemented in a network node, the method comprising

receiving a selection request, the selection request requesting a selection of a secondary network node for establishing dual connectivity for a wireless device;

responsive to the received selection request, selecting the secondary network node before establishing dual connectivity for the wireless device; and

communicating an indication of the selected secondary network node before establishing dual connectivity for the wireless device.

Embodiment B2. The method of Embodiment B1, wherein the communication of the indication of the selected secondary network node comprises a communication to a Session Management Function (SMF) for selecting a User Plane Function (UPF) based on the selected secondary network node.

Embodiment B3. The method of Embodiment B1, wherein the communication of the indication of the selected secondary network node comprises a communication to another node for selecting at least one network entity for the dual connectivity for the wireless device based on the selected secondary network node.

Embodiment B4. The method of any one of Embodiments B1-B3, further comprising establishing the dual connectivity for the wireless device by:

establishing a first Protocol Data Unit (PDU) session and a second PDU session via the network node; and

releasing the second PDU session with the network node and re-establishing the second PDU session with the secondary network node.

Embodiment B5. The method of any one of Embodiments B1-B3, further comprising:

establishing a first Protocol Data Unit (PDU) session with the network node for the wireless device; and

initiating establishment of a second PDU session for the wireless device that comprises the selection of the secondary network node and the communication of the indication of the selected secondary network node before establishing dual connectivity for the wireless device.

Embodiment B6. The method of any one of Embodiments B4 and B5, wherein the first PDU session and the second PDU session are simultaneous PDU sessions for the wireless device.

Embodiment C1. A wireless device (WD) configured to communicate with a network node, the WD configured to, and/or comprising a radio interface and/or processing circuitry configured to:

while being connected to a master network node, receive an indication to establish a Protocol Data Unit (PDU) session with a secondary network node for dual connectivity, the secondary network node being selected before establishing dual connectivity for the wireless device; and

perform Random Access (RA) towards the secondary network node for establishing the dual connectivity for the wireless device.

Embodiment C2. The WD of Embodiment C1, wherein the indication to establish the PDU session with the secondary network node for dual connectivity is a non-access stratum (NAS) message.

Embodiment C3. The WD of Embodiment C1, wherein the indication to establish the PDU session with the secondary network node for dual connectivity is a radio resource control (RRC) message.

Embodiment C4. The WD of any one of Embodiments C1-C3, wherein the processing circuitry is further configured to communicate measurement data to a master network node for selection of a secondary network node for dual connectivity.

Embodiment D1. A method implemented in a wireless device (WD), the method comprising:

while being connected to a master network node, receiving an indication to establish a Protocol Data Unit (PDU) session with a secondary network node for dual connectivity, the secondary network node being selected before establishing dual connectivity for the wireless device; and

performing Random Access (RA) towards the secondary network node for establishing the dual connectivity for the wireless device.

Embodiment D2. The method of Embodiment D1, wherein the indication to establish the PDU session with the secondary network node for dual connectivity is a non-access stratum (NAS) message.

Embodiment D3. The method of Embodiment D1, wherein the indication to establish the PDU session with the secondary network node for dual connectivity is a radio resource control (RRC) message.

Embodiment D4. The method of any one of Embodiments D1-D3, wherein the processing circuitry is further configured to communicate measurement data to a master network node for selection of a secondary network node for dual connectivity.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| AMF | Access and Mobility management Function |
| AS | Application Server |
| BS | Base Station |
| C-MTC | Critical Machine Type Communication |
| CN | Core Network |
| DC | Dual Connectivity |
| DNN | Data Network Name |
| DPI | Deep Packet Inspection |
| EPC | Evolved Packet Core |
| gNB | NR Node B |
| LTE | Long Term Evolution |
| MAC | Medium Access Control |
| MgNB | Master gNB |
| NEF | Network Exposure Function |
| NRF | Network Resource Function |
| OTA | Over The Air |
| PCF | Policy Control Function |
| PDCP | Packet Data Convergence Protocol |
| PSA | PDU Session Anchor |
| RAN | Radio Access Network |
| SgNB | Secondary gNB |
| SMF | Session Management Function |
| SSC | Session and Service Continuity |
| SW | Switch |
| TSN | Time-Sensitive Networking |
| UDM | User Data Management |
| UE | User Equipment |
| UPF | User Plane Function |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to operate as a master node, the network node comprising processing circuitry configured to:
operate in a pre-dual connectivity phase to select a secondary node for establishing dual connectivity for a wireless device already connected to the master node, the selecting being before the establishing;
communicate an indication to a core network node, of the selected secondary node before establishing dual connectivity for the wireless device; and
receive a trigger to set up dual connectivity via the selected secondary node, the trigger being received after the selection.

2. The network node of claim 1, wherein the selecting is based on statistics collected by the network node.

3. The network node of of claim 1, wherein the communication of the indication of the selected secondary node to a core network node is for receipt by a Session Management Function, SMF, for selection of a User Plane Function, UPF, based on the selected secondary node.

4. The network node of claim 1, wherein the communication to the AMF of the indication of the selected secondary node to be forwarded to a Session Management Function, SMF, for selecting a User Plane Function, UPF, based on the selected secondary node.

5. The network node of claim 3, wherein the communication of the indication of the selected secondary node enables associating at least one core node to the selected secondary node, the at least one core node being used to establish dual connectivity to the wireless device via the secondary node.

6. The network node of 1, wherein the processing circuitry is further configured to establish the dual connectivity for the wireless device by:
establishing a first Protocol Data Unit, PDU, session and a second PDU session via the network node; and
releasing the second PDU session with the network node and re-establishing the second PDU session with the secondary node.

7. The network node of claim 1, wherein the processing circuitry is further configured to establish the dual connectivity for the wireless device by:
establishing a first Protocol Data Unit, PDU, session and a second PDU session via the network node; and
releasing the second PDU session with the network node and re-establishing the second PDU session with the secondary node, wherein the first PDU session and the second PDU session are simultaneous PDU sessions for the wireless device.

8. A method in a network node configured to operate as a master node, the method comprising:
operating in a pre-dual connectivity phase to select a secondary node for establishing dual connectivity for a wireless device already connected to the master node, the selecting being before the establishing;
communicating an indication to a core network node of the selected secondary node before establishing dual connectivity for the wireless device; and
receiving a trigger to set up dual connectivity via the selected secondary node, the trigger being received after the selection.

9. The method of claim 8, wherein the selecting is based on statistics collected by the network node.

10. (canceled)

11. The method of claim 8, wherein the communication of the indication of the selected secondary node to the Session Management Function, SMF, is for selecting a User Plane Function, UPF, based on the selected secondary node.

12. The method of claim 8, wherein the communication of the indication of the selected secondary node enables associating at least one core node to the selected secondary node, the at least one core node being used to establish dual connectivity to the wireless device via the secondary node.

13. The method of claim 8, wherein the processing circuitry is further configured to establish the dual connectivity for the wireless device by:
establishing a first Protocol Data Unit, PDU, session and a second PDU session via the network node; and
releasing the second PDU session with the network node and re-establishing the second PDU session with the secondary node.

14. The method of claim 13, wherein the first PDU session and the second PDU session are simultaneous PDU sessions for the wireless device.

15.-20. (canceled)

21. A network node configured to operate as a core node, the network node comprising processing circuitry configured to:
receive an indication from a master node indicating that an intermediate node has been selected as a secondary node for establishing dual connectivity with a wireless device, the receiving occurring before establishing dual connectivity; and
operate as a user plane function for a second packet data unit, PDU, session based on the selected secondary node, the second PDU session being a redundant version of a first PDU session.

22. A method in a network node configured to operate as a core node, the method comprising:
receiving an indication from a master node indicating that an intermediate node has been selected as a secondary node for establishing dual connectivity with a wireless device, the receiving occurring before establishing dual connectivity; and
operating as a user plane function for a second packet data unit, PDU, session based on the selected secondary node, the second PDU session being a redundant version of a first PDU session.

23. The network node of claim 2, wherein the communication of the indication of the selected secondary node to a core network node is for receipt by a Session Management Function, SMF, for selection of a User Plane Function, UPF, based on the selected secondary node.

24. The network node of claim 4, wherein the communication of the indication of the selected secondary node enables associating at least one core node to the selected secondary node, the at least one core node being used to establish dual connectivity to the wireless device via the secondary node.

25. The method of claim 11, wherein the communication of the indication of the selected secondary node enables associating at least one core node to the selected secondary node, the at least one core node being used to establish dual connectivity to the wireless device via the secondary node.

26. The method of claim 9, wherein the processing circuitry is further configured to establish the dual connectivity for the wireless device by:
establishing a first Protocol Data Unit, PDU, session and a second PDU session via the network node; and
releasing the second PDU session with the network node and re-establishing the second PDU session with the secondary node.

27. The method of claim 11, wherein the processing circuitry is further configured to establish the dual connectivity for the wireless device by:
establishing a first Protocol Data Unit, PDU, session and a second PDU session via the network node; and
releasing the second PDU session with the network node (16) and re-establishing the second PDU session with the secondary node.
